(19) United States
(12) Patent Application Publication
(10) Pub. No.: US 2024/0364649 A1
(43) Pub. Date: Oct. 31, 2024

(54) MESSAGE QUOTING METHOD AND APPARATUS THEREOF

(71) Applicant: VIVO MOBILE COMMUNICATION CO., LTD., Dongguan (CN)

(72) Inventor: Jiawei LIU, Dongguan (CN)

(73) Assignee: VIVO MOBILE COMMUNICATION CO., LTD., Dongguan (CN)

(21) Appl. No.: 18/764,138

(22) Filed: Jul. 3, 2024

Related U.S. Application Data
(63) Continuation of application No. PCT/CN2023/070235, filed on Jan. 3, 2023.

(30) Foreign Application Priority Data
Jan. 4, 2022 (CN) 202210004808.1

(51) Int. Cl. H04L 51/046; H04L 51/56; H04M 1/72436; H04M 1/72469

(52) U.S. Cl. CPC H04L 51/046; H04L 51/56; H04M 1/72436; H04M 1/72469

(57) ABSTRACT

This application discloses a message quoting method and an apparatus thereof, and pertains to the field of terminals. The method includes: displaying a first screen of a first application, where the first screen includes X first to-be-quoted messages and Y first session objects; receiving a first input from a user, where the first input is used to associate a target to-be-quoted message in the X first to-be-quoted messages with a target object in the Y first session objects, and the target to-be-quoted message includes a target session message in a second application; receiving a second input from the user, where the second input is used to instruct sending information to the target object; and sending target information to the target object according to the second input, where the target information includes at least one to-be-quoted message in the target to-be-quoted message; where both X and Y are positive integers.

### CROSS-REFERENCE TO RELATED APPLICATIONS

This application is a continuation of International Application No. PCT/CN2023/070235, filed on Jan. 3, 2023, which claims priority to Chinese Patent Application No. 202210004808.1, filed on Jan. 4, 2022. The entire contents of each of the above-referenced applications are expressly incorporated herein by reference.

### TECHNICAL FIELD

This application pertains to the field of terminals, and specifically relates to a message quoting method and an apparatus thereof.

### BACKGROUND

Message quoting means that the previous content can be quoted when a message is sent. It is a common interactive form in instant messaging scenarios. Some existing Applications (APPs) all support message quoting.

In the related art, the process of message quoting is as follows: in a chat screen of an application, finding a message that needs to be quoted and selecting a quoting function button to copy the quoted message to a chat box on the same chat screen, inputting new content in the chat box, and then sending the quoted message and the new content through the chat box on the same chat screen, so as to realize message quoting.

However, this quoting method in the related art is only applicable to a scenario that a message is quoted between different chat objects within the same application, and is not applicable to cross-application quoting scenarios.

### SUMMARY

Embodiments of this application provide a message quoting method and an apparatus thereof.

According to a first aspect, an embodiment of this application provides a message quoting method, where the method includes:
displaying a first screen of a first application, where the first screen includes X first to-be-quoted messages and Y first session objects;
receiving a first input from a user, where the first input is used for associating a target to-be-quoted message in the X first to-be-quoted messages with a target object in the Y first session objects, and the target to-be-quoted message includes a target session message in a second application;
receiving a second input from the user, where the second input is used for instructing to send information to the target object; and
sending target information to the target object according to the second input, where the target information includes at least one to-be-quoted message in the target to-be-quoted message; where
both X and Y are positive integers.

According to a second aspect, an embodiment of this application provides a message quoting apparatus, where the apparatus includes:
a display module, configured to display a first screen of a first application, where the first screen includes X first to-be-quoted messages and Y first session objects;
a receiving module, configured to receive a first input from a user, where the first input is used for associating a target to-be-quoted message in the X first to-be-quoted messages with a target object in the Y first session objects, and the target to-be-quoted message includes a target session message in a second application; and
the receiving module is further configured to receive a second input from the user, where the second input is used for instructing to send information to the target object; and
a sending module, configured to send target information to the target object according to the second input, where the target information includes at least one to-be-quoted message in the target to-be-quoted message; where
both X and Y are positive integers.

According to a third aspect, an embodiment of this application provides an electronic device, where the electronic device includes a processor, a memory, and a program or instructions stored in the memory and capable of running on the processor, and when the program or the instructions are executed by the processor, the steps of the method according to the first aspect are implemented.

According to a fourth aspect, an embodiment of this application provides a readable storage medium, where a program or instructions are stored in the readable storage medium, and when the program or the instructions are executed by a processor, the steps of the method according to the first aspect are implemented.

According to a fifth aspect, an embodiment of this application provides a chip, where the chip includes a processor and a communication interface, the communication interface is coupled to the processor, and the processor is configured to run a program or instructions so as to implement the method according to the first aspect.

In the embodiments of this application, a first screen of a first application is displayed, where the first screen includes X first to-be-quoted messages and Y first session objects; a first input from a user is received, where the first input is used for associating a target to-be-quoted message in the X first to-be-quoted messages with a target object in the Y first session objects, and the target to-be-quoted message includes a target session message in a second application; a second input from the user is received, where the second input is used for instructing to send information to the target object; and target information is sent to the target object according to the second input, where the target information includes at least one to-be-quoted message in the target to-be-quoted message; where both X and Y are positive integers. In this way, on a screen of the first application, the first input is used to associate the target to-be-quoted message including the target session message in the second application with the target object, such that at least one to-be-quoted message in the target to-be-quoted message can be sent to the target object subsequently, allowing the target session message in the second application to be quoted in the first application, thereby solving the problem that the quoting mode in the related art is not applicable to cross-application quoting scenarios.

### BRIEF DESCRIPTION OF DRAWINGS

FIG. 1 is a flow block diagram of a message quoting method according to an embodiment of this application;

FIG. 2-1, FIG. 2-2, and FIG. 2-3 are schematic diagrams of screens for a message quoting method according to an embodiment of this application in practical application scenarios;

FIG. 3-1, FIG. 3-2, and FIG. 3-3 are schematic diagrams of screens for a message quoting method according to an embodiment of this application in practical application scenarios;

FIG. 4-1, FIG. 4-2, and FIG. 4-3 are schematic diagrams of screens for a message quoting method according to an embodiment of this application in practical application scenarios;

FIG. 5-1, FIG. 5-2, FIG. 5-3, and FIG. 5-4 are schematic diagrams of screens for a message quoting method according to an embodiment of this application in practical application scenarios;

FIG. 6-1, FIG. 6-2, FIG. 6-3, and FIG. 6-4 are schematic diagrams of screens for a message quoting method according to an embodiment of this application in practical application scenarios;

FIG. 7 is a flow block diagram of a message quoting method according to an embodiment of this application;

FIG. 8 is a structural block diagram of a message quoting apparatus according to an embodiment of this application; and

FIG. 9 is a schematic diagram of a hardware structure of an electronic device according to various embodiments of this application.

### DETAILED DESCRIPTION

The following describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application without creative efforts shall fall within the protection scope of this application.

The terms “first”, “second”, and the like in this specification and claims of this application are used to distinguish between similar objects rather than to describe a specific order or sequence. It should be understood that the data used in this way is interchangeable in appropriate circumstances such that the embodiments of this application can be implemented in other orders than the order illustrated or described herein. In addition, “and/or” in the specification and claims represents at least one of connected objects, and the character “/” generally indicates that the associated objects have an “or” relationship.

The following describes in detail the message quoting method provided in the embodiments of this application through specific embodiments and application scenarios thereof with reference to the accompanying drawings. In this embodiment of this application, the first to tenth inputs mentioned later can be input in various modes, including input by sliding, tapping, dragging, function button, and the like. The input modes do not constitute the limitation on this application.

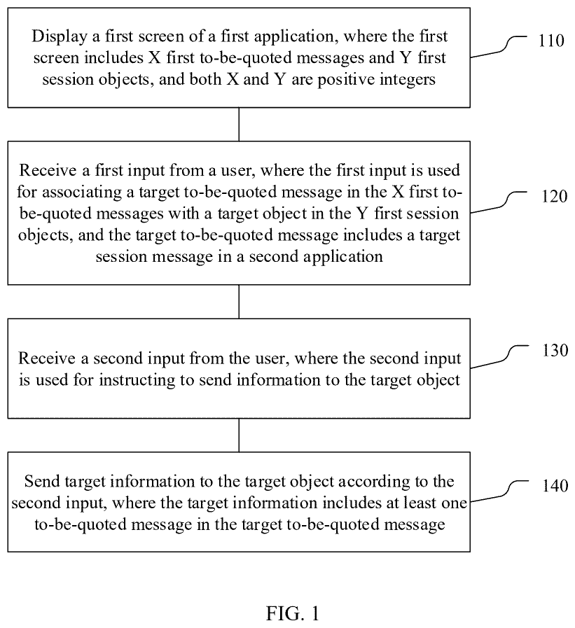

As shown in FIG. 1, an embodiment of this application provides a message quoting method. The method can be executed by an electronic device, in other words, the method can be executed by software or hardware installed on the electronic device. The method includes the following steps.

Step 110: Display a first screen of a first application, where the first screen includes X first to-be-quoted messages and Y first session objects, and both X and Y are positive integers.

The first application may be an application with message receiving and message sending functions, for example, WeChat, QQ, and DingTalk. The first application may include various screens, such as home screen, contacts screen, dynamics screen, and WeChat official account screen. The first screen of the first application may be the home screen of the first application. The first to-be-quoted message may include to-be-quoted messages sent to the first application by other applications. The first session object may include contacts, group chat, WeChat official account, or the like in the first application. On the first screen of the first application, the first to-be-quoted message can be displayed in various forms, such as a card, an abbreviated character, and a fan icon.

For case of description of the message quoting method provided in this embodiment of this application, the first application being WeChat, the first screen being a home screen, and the first to-be-quoted message being displayed in a form of card are used as an example below to explain the solution provided in the embodiments of this application.

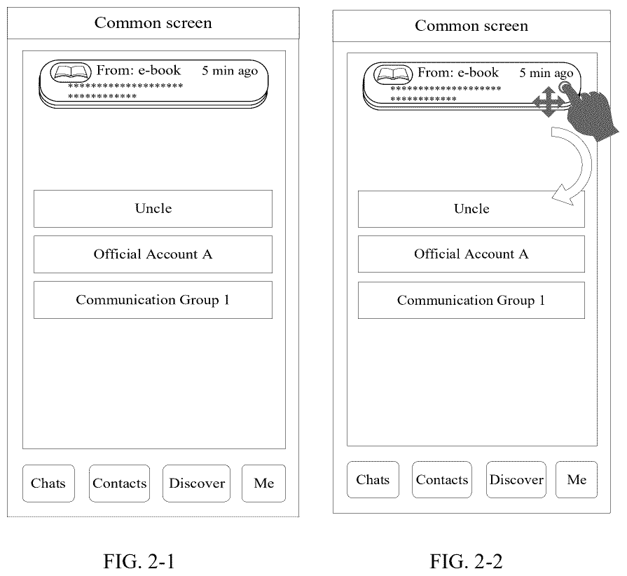

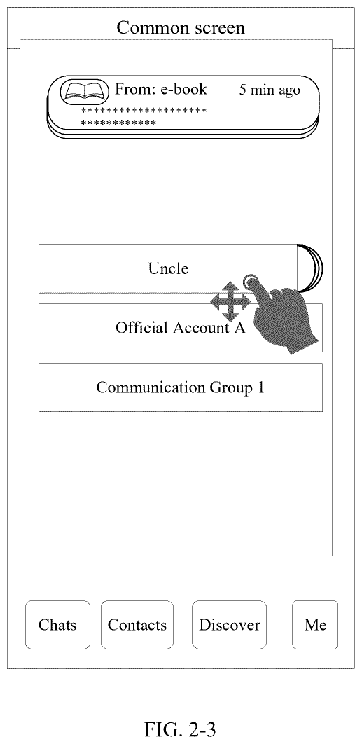

In an embodiment, as shown in FIG. 2-1, after a user selects a to-be-quoted message from another application and sends the selected to-be-quoted message to WeChat, the to-be-quoted message selected by the user and a to-be-selected object can be displayed on the home screen of WeChat. When there are multiple first to-be-quoted messages, multiple cards will be displayed in a form of quotation book. When being displayed, the first to-be-quoted message with the last quoting time can be displayed in the form of card at the forefront of the quotation book according to the chronological relationship of the first to-be-quoted messages. The card at the forefront of the quotation book can display information of the to-be-quoted message, and information of other cards can be hidden. The information of the to-be-quoted message may include a source of the message, a quoted time, and quoted content. The quoted content can be displayed according to a type of a quoted target session message. For example, if the target session message is a text, the quoted content may display abbreviated text information; if the target session message is an image, the quoted content may display the name of the image; and if the target session message is a file, the quoted content may be a name of the file.

Step 120: Receive a first input from a user, where the first input is used for associating a target to-be-quoted message in the X first to-be-quoted messages with a target object in the Y first session objects, and the target to-be-quoted message includes a target session message in a second application.

The target object includes an object that can receive input and provide output, for example, a chat object.

The first input from the user is received on the first screen of the first application. The first screen includes X first to-be-quoted messages and Y first session objects. The user selects a target to-be-quoted message from the X first to-be-quoted messages and a target object from the Y first session objects through the first input, and the associating the target to-be-quoted message with the target object includes determining the target object as a receiving object of the target to-be-quoted message. The target to-be-quoted message may include all of the X first to-be-quoted messages, or may include some of the X first to-be-quoted messages, and the target to-be-quoted message includes the target session message in the second application. The second application may include one or more applications different from the first application. The target object may include all of the Y first session objects or some of the Y first session objects. The message content of the target session message may support any type of message, and specifically, it may include text, image, file, link, and the like.

In an embodiment, the target object includes L objects, where L is a positive integer greater than 1. The first input includes L sub-inputs, where one of the L sub-inputs is used for associating the target to-be-quoted message with one of the L objects. In this way, multiple objects can consume the target to-be-quoted message, implementing reuse of the target to-be-quoted message.

In an embodiment, the user can select L objects from the Y first session objects and take the L objects as target objects. The first input includes L sub-inputs, which means that the first input needs to be executed L times to associate the target to-be-quoted message with the target object.

It should be noted that every time the first input is executed, the X first to-be-quoted messages on the first screen of the first application may not change, such that they can be repeatedly associated with other target objects. After an operation of deleting the entire quotation book is received from the user, the X first to-be-quoted messages can be deleted and not displayed on the first screen.

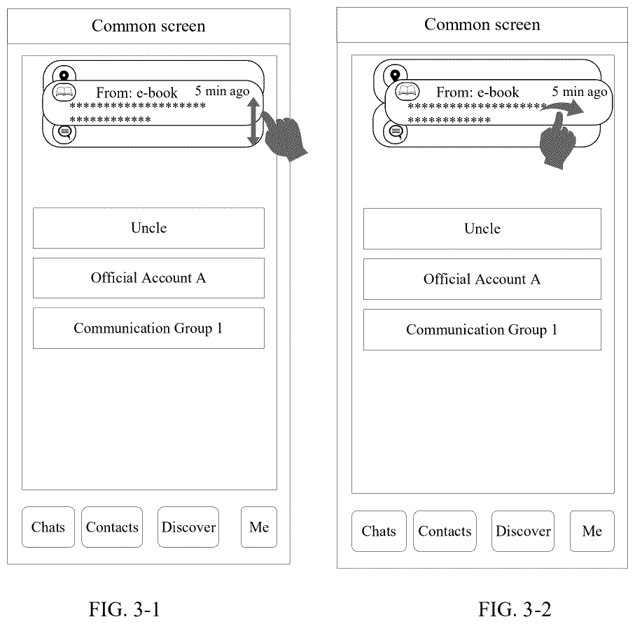

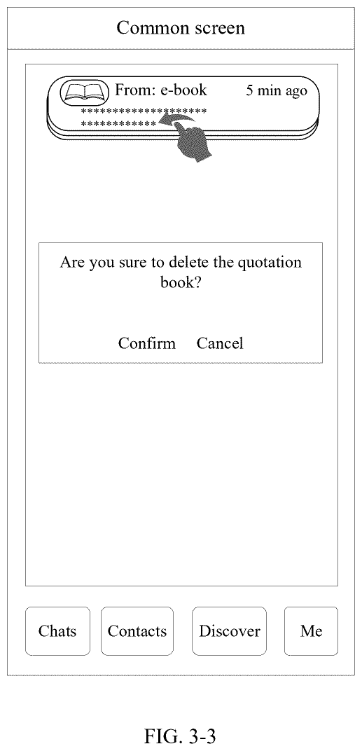

The first input being a long-press drag input is used as an example. In an embodiment, as shown in FIG. 2-1, the home screen of WeChat has a first session object display box, such as a display box of contact uncle, a display box of communication group 1, and a display box of WeChat official account A. Multiple first to-be-quoted messages may be displayed on the home screen of the first application in a form of quotation book. As shown in FIG. 2-2, the first input may be long pressing the quotation book and dragging it to a display box of the target object, or may be long pressing the quotation book, selecting a target to-be-quoted message from the quotation book, and then dragging the target to-be-quoted message to a display box of the target object. As shown in FIG. 2-3, after the target to-be-quoted message is associated with the target object, the display box of the target object can present corresponding changes according to the number of target to-be-quoted messages. For example, if the number of target to-be-quoted messages is one, there may be one elliptic shape on the right end of the display box of the target object; and if the number of target to-be-quoted messages is three, there may be three corresponding elliptic shapes on the right end of the display box of the target object.

Step 130: Receive a second input from the user, where the second input is used for instructing to send information to the target object.

After the target to-be-quoted message is associated with the target object according to the first input, the information may not be sent at that time. The information may be sent to the target object after the second input from the user has been received.

Step 140: Send target information to the target object according to the second input, where the target information includes at least one to-be-quoted message in the target to-be-quoted message.

After the target to-be-quoted message is associated with the target object according to the first input, the display box of the target object can be tapped to access a chat screen, and the target to-be-quoted message is displayed in the input box of the chat screen. In actual quoting, the target to-be-quoted messages can be edited. For example, the order of the target to-be-quoted messages is adjusted, or some target to-be-quoted messages are deleted. After editing, new message content is input in the input box and combined with at least one to-be-quoted message in the target to-be-quoted messages into target information, and then the target information can be sent to the target object through the second input, for example, tapping the send function button.

In an embodiment, as shown in FIG. 3-1, the first screen may include X first to-be-quoted messages, where the X first to-be-quoted messages may be edited before the first input is received. As shown in FIG. 3-1, the information of the quoted message in the card can be viewed by sliding up and down, and a quotation in the quotation book or the entire quotation book can be deleted using a specified operation (for example, swiping). As shown in FIG. 3-2, selecting a quotation and sliding it to the right can delete the selected to-be-quoted message from the quotation book. In this embodiment of the application, after the target object is associated with the target to-be-quoted message in response to the received first input, the quotation book can also be selected on the first screen to delete the entire quotation book. As shown in FIG. 3-3, after the user selects the quotation book and slides it to the left, a dialog box for confirming the deletion of the quotation book pops up. After the user selects the confirm option, all the to-be-quoted messages are deleted.

In this embodiment of this application, a first screen of a first application is displayed, where the first screen includes X first to-be-quoted messages and Y first session objects; a first input from a user is received, where the first input is used for associating a target to-be-quoted message in the X first to-be-quoted messages with a target object in the Y first session objects, and the target to-be-quoted message includes a target session message in a second application; a second input from the user is received, where the second input is used for instructing to send information to the target object; and target information is sent to the target object according to the second input, where the target information includes at least one to-be-quoted message in the target to-be-quoted message; where both X and Y are positive integers. In this way, on a screen of the first application, the first input is used to associate the target to-be-quoted message including the target session message in the second application with the target object, such that at least one to-be-quoted message in the target to-be-quoted message can be sent to the target object subsequently, allowing the target session message in the second application to be quoted in the first application, thereby solving the problem that the quoting mode in the related art is not applicable to cross-application quoting scenarios.

In an embodiment, before the step 110 of displaying a first screen of a first application, the message quoting method provided in the embodiments of this application may further include: receiving a third input from the user to the target session message in the second application; displaying M application icons according to the third input, where the M application icons are used for indicating icons of applications different from the second application; receiving a fourth input from the user, where the fourth input is used for selecting N target application icons from the M application icons, and the N target application icons include an icon of the first application; and quoting, according to the fourth input, the target session message in N target applications corresponding to the N target application icons. In this way, the target application to which the to-be-quoted message needs to be added can be selected depending on the actual situation, where the to-be-quoted message includes the target session message in the second application, making it convenient for the target application to quote the target session message in the second application subsequently.

The X first to-be-quoted messages on the first screen of the first application may come from the second application. The second application may include one or more applications different from the first application. The second application may display M application icons in response to the third input for the target session message. The M application icons can include icons of applications that are running in the background, and the user can also tap the add function button according to actual needs to add an icon of an application that needs to use to-be-quoted messages. The application icon may include an application sign, an application name, and the like. Through the fourth input, the user can select N target application icons including the first application icon from the M application icons, so as to quote the target session message in N target applications corresponding to the N target application icons. The first screens of the N target applications can correspondingly display a quotation in the second application for the target session message.

In an embodiment, the user can select the target session message from the second application, and then execute the third input after selecting the target session message. The third input may be an input for a hyper-quote function button. For example, after the target session message is tapped, a hyper-quote menu pops up on the target session message screen, where the hyper-quote menu includes the hyper-quote function button. When the user taps the hyper-quote function button, an application menu will pop up on the current screen, with M application icons displayed in the application menu. In this embodiment of this application, the third input can also be a preset touch input, such as pressing and holding the target session message (for example, for 8 seconds), an application menu pops up on the current screen, with the M application icons displayed in the application menu. After that, the user can select N target application icons from the M application icons through the fourth input, where the N target application icons include the icon of the first application. After the N target application icons are selected, the target session message is quoted in N target applications corresponding to the N target application icons. When all of the N target applications receive the quotation of the target session message, a switching operation can be triggered to switch from the current screen to an split-screen display screen for the N target applications, and the user can select an application to execute a subsequent operation depending on the actual situation. In some embodiments, the switching operation may be not triggered, and the user manually starts a corresponding application to execute a subsequent operation.

It should be noted that the target session message may be a historical message in group chat, a historical message in WeChat official account, or a historical message in a one-on-one chat between the current user and another user.

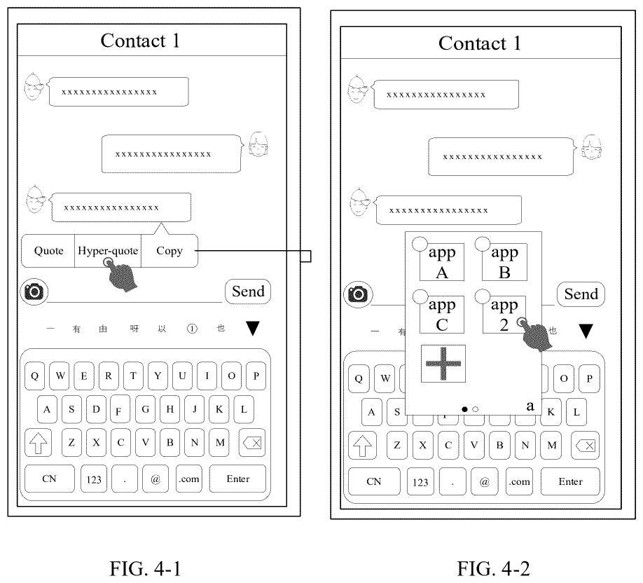

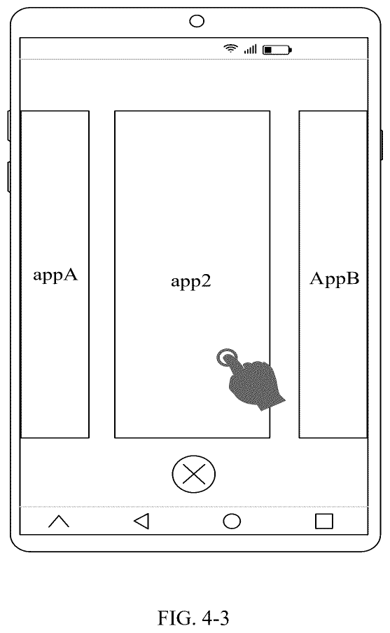

An example of a practical application scenario will be explained with reference to FIG. 4-1, FIG. 4-2, and FIG. 4-3.

As shown in FIG. 4-1, the user selects a target session message to be quoted from a historical message of the second application (for example, app1), and after determining the target session message, the user can trigger a hyper-quote menu through a touch operation in the dialog box, and tap a hyper-quote function button in the hyper-quote menu to pop up the application menu shown in FIG. 4-2. The application menu may include application icons of multiple applications different from the second application, such as appA, appB, appC, and app2. The user can tap the application icon to select a target application icon. After the selection, the quotation of the target session message is put into the target application. As shown in FIG. 4-3, when the target application receives the quotation of the target session message, the current screen can be automatically switched to the split-screen display screen of the target application, and the user can select an application on the split-screen display screen and directly access the application to quote the target session message. When the target application receives the quotation of the target session message, the current screen may not change, and the user can start the target application manually to quote the target session message in the target application.

In an embodiment, the target to-be-quoted message includes K to-be-quoted messages, where K is a positive integer greater than or equal to 2 and K is less than or equal to X. For this case, before the step 130 of receiving a second input from the user, the message quoting method provided in the embodiments of the present disclosure may further include: displaying a second screen, where the second screen includes the K to-be-quoted messages; and receiving a fifth input, where the fifth input is used for adjusting a positional relationship among the K to-be-quoted messages. Accordingly, in the step 140 of sending the target information to the target object according to the second input, the target information includes the K to-be-quoted messages whose positional relationship has been adjusted. In this way, the positional relationship of the to-be-quoted messages can be adjusted, which is beneficial to better understanding of the to-be-quoted messages.

The first input may be used for associating a target to-be-quoted message in the X first to-be-quoted messages with a target object in the Y first session objects. In some embodiments, the K to-be-quoted messages can be selected as target to-be-quoted messages from the X first to-be-quoted messages. The second screen can be a chat screen between the user and the target object, and the target information has not been sent on the current chat screen. The K to-be-quoted messages can be displayed in the input box of the chat screen. It can be understood that the K to-be-quoted messages will be sent to the target object as part of the target information. For better understanding of the quoted target session message, the positional relationship among the K to-be-quoted messages can be adjusted to correspondingly adjust a positional relationship among the target session messages in the to-be-quoted messages. The positional relationship among the K to-be-quoted messages can be adjusted according to a chronological order of quotations and importance of content. For example, when the target session message is in a form of file, text, and image, the importance of content decreases in sequence, and a quotation with a file name as the quoted content can be adjusted to the forefront of the quotation book. On the second screen, new message content can be input, and in response to the second input, the target information is sent to the target object, where the target information includes the K to-be-quoted messages whose positional relationship has been adjusted.

In this embodiment of this application, the sequence of target session messages in the to-be-quoted messages can be correspondingly adjusted by adjusting the positions of the K target to-be-quoted messages using the fifth input on the second screen, such that after the target information is sent, the target information can be ranked in a certain chronological sequence or by content importance, facilitating understanding by the information receiver.

An example of a practical application scenario will be explained with reference to FIG. 5-1 and FIG. 5-2.

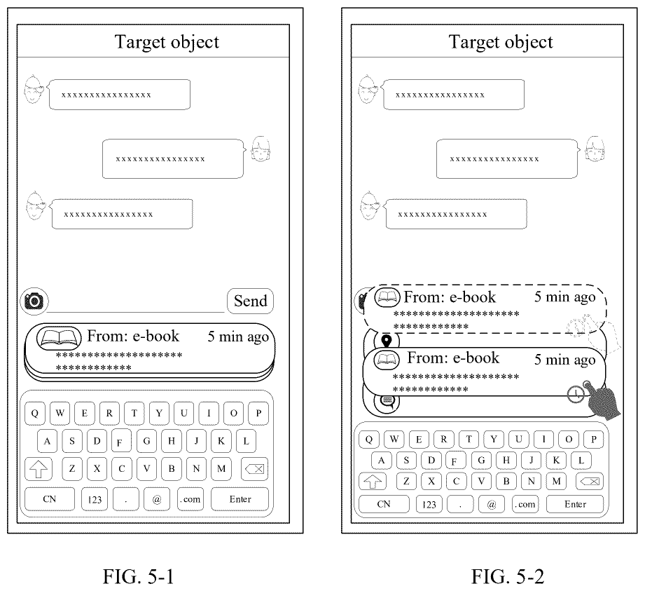

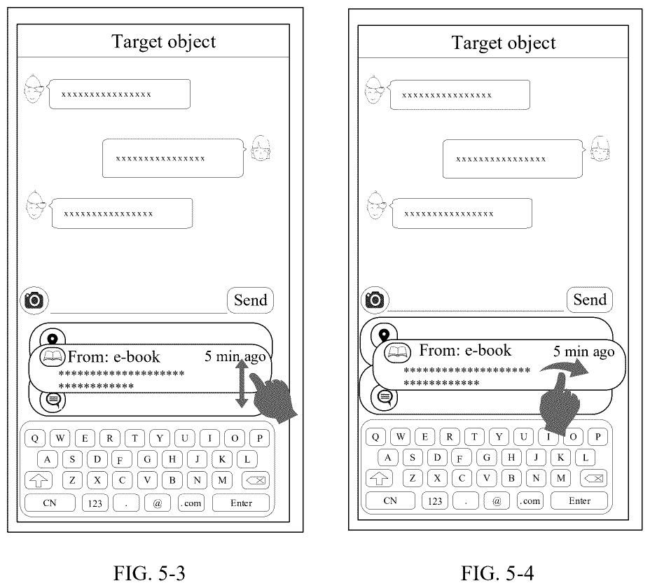

As shown in FIG. 5-1, after the target to-be-quoted message is associated with the target object according to the first input, the user can tap the display box of the target object to access the second screen. The target to-be-quoted messages can be wholly displayed in a chat box of the second screen in a form of quotation book. Each target to-be-quoted message can be correspondingly displayed as a card in the quotation book. As shown in FIG. 5-2, the order of the target to-be-quoted messages can be adjusted using a specified input operation, such as long pressing and dragging a target to-be-quoted message in the quotation book. When the target information is sent to the target object according to the second input, each to-be-quoted message contained in the target information will be presented in the adjusted order.

In an embodiment, the target to-be-quoted message includes K to-be-quoted messages, where K is a positive integer greater than or equal to 2 and K is less than or equal to X. For this case, before the step 130 of receiving a second input from the user, the message quoting method provided in the embodiments of this application may further include: displaying a second screen, where the second screen includes the K to-be-quoted messages; receiving a sixth input, where the sixth input is used for instructing to delete at least one to-be-quoted message in the K to-be-quoted messages; and displaying a third screen according to the sixth input, where the third screen includes P to-be-quoted messages, and P is a positive integer less than K. Accordingly, the step 140 of sending target information to the target object according to the second input includes: sending the target information to the target object according to the second input, where the target information includes P to-be-quoted messages. In this way, deletion of the to-be-quoted messages can be implemented, which is conducive to the flexible use of the to-be-quoted messages to better meet user needs.

The first input may be used for associating a target to-be-quoted message in the X first to-be-quoted messages with a target object in the Y first session objects. In some embodiments, the K to-be-quoted messages can be selected as target to-be-quoted messages from the X first to-be-quoted messages. The second screen can be a chat screen between the user and the target object, and the target information has not been sent on the current chat screen. The K to-be-quoted messages can be displayed in the input box of the chat screen. It can be understood that the K to-be-quoted messages may include to-be-quoted messages with substantially the same quotation content or to-be-quoted message that the user does not need to send to the target object, so at least one of the K to-be-quoted messages can be deleted through the sixth input on the second screen. The third screen is a screen after some to-be-quoted messages in the target to-be-quoted message on the second screen are deleted, and P to-be-quoted messages are displayed in the input box of the chat screen on the third screen. On the third screen, new message content can be input, and after the input of the new message content is completed, the target information can be sent to the target object in response to the second input, where the target information includes P to-be-quoted messages.

In this embodiment of this application, before the target information is sent, the number of to-be-quoted messages can be reduced in a timely manner by deleting some of the K to-be-quoted messages using the sixth input on the second screen, thereby avoiding duplication of quoted content or re-sending of a to-be-quoted message that has already been sent.

An example of a practical application scenario will be explained with reference to FIG. 5-1, FIG. 5-3, and FIG. 5-4.

As shown in FIG. 5-1, after the target to-be-quoted message is associated with the target object according to the first input, the user can tap the display box of the target object to access the second screen. The target to-be-quoted messages can be wholly displayed in a chat box of the second screen in a form of quotation book. Each to-be-quoted message can be correspondingly displayed as a card in the quotation book. As shown in FIG. 5-3, the user can view content of a to-be-quoted message in the quotation book by sliding up and down. As shown in FIG. 5-4, the user can select a to-be-quoted message displayed in a form of card and slide it to the right to delete the selected to-be-quoted message from the quotation book. In the case of sending the target information to the target object according to the second input, the to-be-quoted messages contained in the target information may be to-be-quoted messages remaining after some of the to-be-quoted messages are deleted from the target to-be-quoted message.

In an embodiment, after the step 140 of sending target information to the target object according to the second input, the message quoting method provided in the embodiments of this application further includes: displaying a fourth screen, where the fourth screen includes the at least one to-be-quoted message in the target to-be-quoted message; receiving a seventh input for a specified to-be-quoted message in the at least one to-be-quoted message, where the seventh input is used for triggering a jump to a specified application corresponding to the specified to-be-quoted message; displaying a fifth screen according to the seventh input, where the fifth screen is a screen of the specified application including the specified to-be-quoted message and context of the specified to-be-quoted message; where the specified to-be-quoted message on the fifth screen is marked with a mark. In this way, the source and context of the specified to-be-quoted message can be easily viewed through the seventh input, which helps to understand the content of the specified to-be-quoted message more accurately.

The fourth screen may be a chat screen after the target information is sent to the target object, and the target object can view the target information at this point. After the target information is sent, the target to-be-quoted message, as part of the target information, is displayed on the fourth screen in a form of historical message. When the user needs to view the context of the target to-be-quoted message, the user can select at least one to-be-quoted message from the target information as the specified to-be-quoted message and execute the seventh input. The seventh input can trigger a jump from the fourth screen to the fifth screen. The fifth screen is a screen of the specified application corresponding to the specified to-be-quoted message, including the specified to-be-quoted message and the context of the specified to-be-quoted message. In some embodiments, the fifth screen may be a screen where the target information is located in the middle of a chat screen of the specified application. When the specified to-be-quoted message is displayed on the fifth screen, the specified to-be-quoted message can be marked. For example, a dialog box of the specified to-be-quoted message is marked in red, or the background color of the dialog box of the specified to-be-quoted message is adjusted to a dark color, which is convenient for distinguishing the specified to-be-quoted message from the context of the specified to-be-quoted message.

It should be noted that the received seventh input can be input by the user who sent the target information or by the target object who received the target information. In some embodiments, the user who has sent the target information can use the seventh input to jump to the screen of the specified application where the target information appears, so as to check whether the context of the specified to-be-quoted message can effectively explain the content the user wants to express or communicate, and to check the correctness and effectiveness of the content of the specified to-be-quoted message. After receiving the target information, the target object receiving the target information can use the seventh input to jump to the fifth screen to view the specified to-be-quoted message and its context, facilitating understanding of the communication scenario and content of the specified to-be-quoted message.

In an embodiment, the fifth screen may further include a back icon (for example, a back button displayed on the fifth screen), and after a tenth input for the back icon is received on the fifth screen, the user can return to the fourth screen. In this way, provision of the back icon on the fifth screen makes it convenient to return to the fourth screen.

It can be understood that after viewing the target session message on the fifth screen, the user can tap the back button on the fifth screen to return to the fourth screen and input new message content on the fourth screen.

In this embodiment of this application, a jump is triggered through the seventh input to jump from the fourth screen displaying the target information to an application corresponding to the target to-be-quoted message contained in the target information, and the fifth screen including the target to-be-quoted message and the context of the target to-be-quoted message is displayed in the corresponding application, such that the usage scenario and what is expressed by the target to-be-quoted message can be understood in combination with the context content.

An example of a practical application scenario will be explained with reference to FIG. 6-1 and FIG. 6-2.

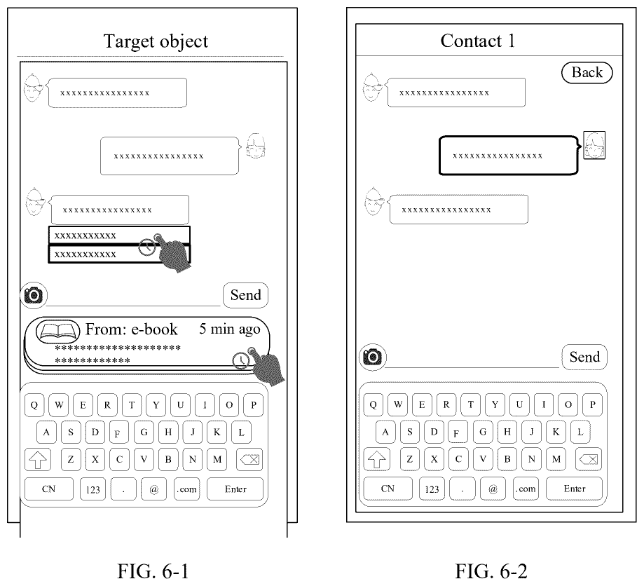

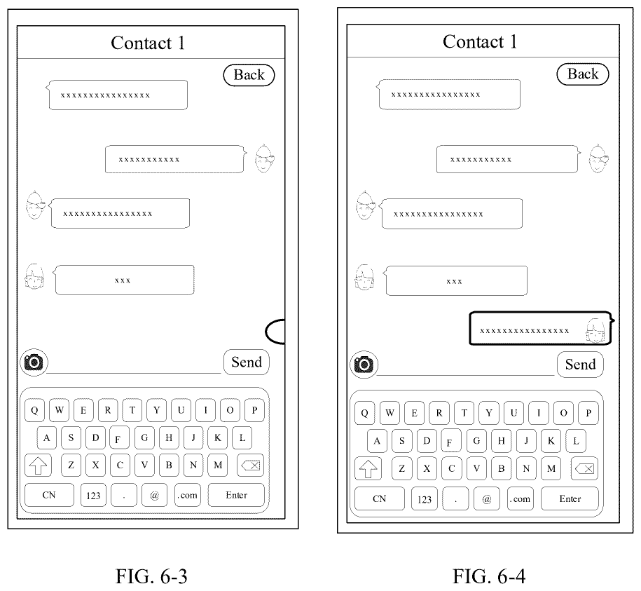

As shown in FIG. 6-1, the fourth screen is displayed after the target information is sent to the target object according to the second input. The target information includes at least one to-be-quoted message in the target to-be-quoted messages. The user can select a specified to-be-quoted message in the target information (for example, the uppermost to-be-quoted message), and according to the seventh input (for example, a long-press input) and trigger a jump to the initial position of the specified to-be-quoted message, and the fifth screen is displayed. As shown in FIG. 6-2, the fifth screen is a screen of the specified application corresponding to the specified to-be-quoted message, including the specified to-be-quoted message and the context of the specified to-be-quoted message. On the fifth screen, the context of the specified to-be-quoted message can be viewed. For differentiation between the specified to-be-quoted message and context of the specified to-be-quoted message, the background color of a dialog box of the specified to-be-quoted message can be adjusted to a dark color. The fifth screen may also include a back icon. After the tenth input (for example, a tap input) for the back icon is received on the fifth screen, the user can return to the fourth screen and input new message content on the fourth screen.

In an embodiment, after the displaying a fifth screen, the message quoting method of this application further includes: receiving an eighth input, where the eighth input is used for viewing the context of the specified to-be-quoted message; displaying a sixth screen according to the eighth input, where the sixth screen is a screen on which the content of the specified to-be-quoted message is replaced with an icon of the specified to-be-quoted message; receiving a ninth input for the icon of the specified to-be-quoted message on the sixth screen; and displaying the fifth screen according to the ninth input. In this way, it is convenient to return to the fifth screen containing the specified to-be-quoted message and its context through the input for the icon of the specified to-be-quoted message.

The fifth screen is a screen of the specified application corresponding to the specified to-be-quoted message, including the specified to-be-quoted message and the context of the specified to-be-quoted message. However, the context of the specified to-be-quoted message may change with a screen up/down operation. Therefore, during viewing of the context content, it is possible that a screen does not contain the specified to-be-quoted message. For this case, after viewing the content of the fifth screen, if the user wants to continue to further view other content, the user can execute the eighth input (for example, an input for screen up/down). In this case, the sixth screen can be displayed according to the eighth input. The sixth screen does not contain the specified to-be-quoted message. In order to facilitate the return to the screen corresponding to the specified to-be-quoted message, the icon of the specified to-be-quoted message can be displayed on the sixth page so as to replace the content of the specified to-be-quoted message with the icon of the specified to-be-quoted message. After the ninth input is executed on the icon of the specified to-be-quoted message, the fifth screen can be displayed.

In this embodiment of this application, when the user views the context that is not on the same chat screen as the specified to-be-quoted message, the specified to-be-quoted message can be displayed on that screen in a form of icon, such that the user can tap the icon at any time during the viewing process to return to the fifth screen, preventing the initial position of the specified to-be-quoted message from being lost.

An example of a practical application scenario will be explained with reference to FIG. 6-2 to FIG. 6-4.

As shown in FIG. 6-2, the fifth screen is currently displayed, and the target information can be located in the middle of the screen. After the eighth input, for example, sliding down to next screen, is received, the sixth screen can be displayed according to the eighth input. As shown in FIG. 6-3, there is no target information on the sixth screen in the specified application. To allow the user to view the target information, the sixth screen can display the icon of the specified to-be-quoted message. The icon may be the avatar of the sender of the target information or a specified icon, such as an arc icon and an asterisk icon. After the user navigates to the next screen from the fifth screen, if the avatar of the sender of the target information is located on the left side of the screen, the target information is folded to the left side of the screen as an icon; and if the avatar of the sender of the target information is located on the right side of the screen, the target session message is folded to the right side of the screen as an icon, as shown in FIG. 6-3. The icon can be located above the input box of the sixth screen to avoid blocking other messages. The user can tap the icon to display the target information (as shown in FIG. 6-4), and double-tap the icon to jump back to the fifth screen (for example, the screen shown in FIG. 6-2).

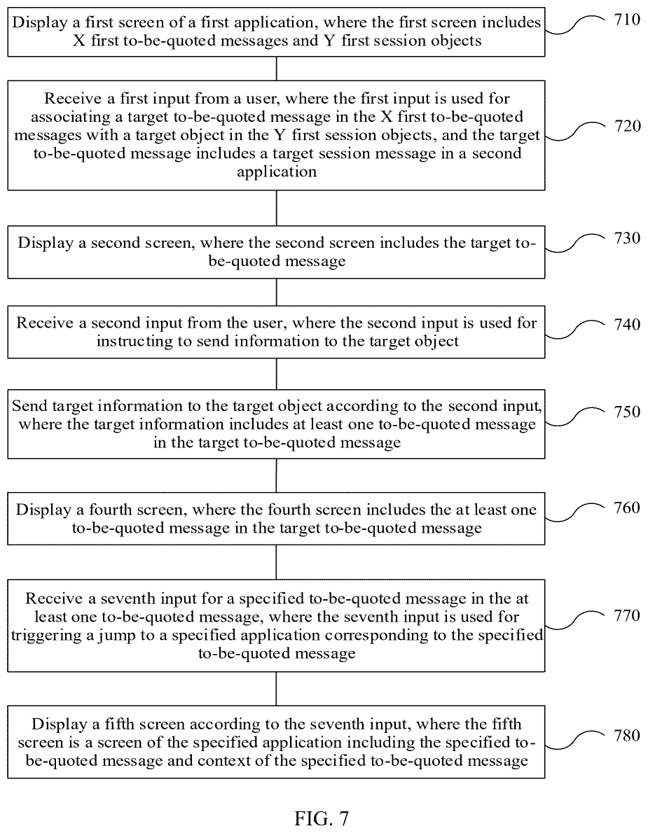

For better understanding of the message quoting method provided in the embodiments of this application, further explanation will be given below with reference to specific examples. As shown in FIG. 7, an embodiment of this application provides a message quoting method, where the method includes the following steps.

Step 710: Display a first screen of a first application, where the first screen includes X first to-be-quoted messages and Y first session objects.

Step 720: Receive a first input from a user, where the first input is used for associating a target to-be-quoted message in the X first to-be-quoted messages with a target object in the Y first session objects, and the target to-be-quoted message includes a target session message in a second application.

In this embodiment, the target to-be-quoted message includes K to-be-quoted messages. The target object may include an object capable of receiving an input and providing an output.

Step 730: Display a second screen, where the second screen includes the target to-be-quoted message.

After the step 730 of displaying a second screen, a fifth input and/or a sixth input may be received, where the fifth input is used for adjusting a positional relationship among the K to-be-quoted messages and the sixth input is used for deleting at least one to-be-quoted message in the K to-be-quoted messages.

In this embodiment of this application, the fifth input and the second input can be selected as required.

Step 740: Receive a second input from the user, where the second input is used for instructing to send information to the target object.

Step 750: Send target information to the target object according to the second input, where the target information includes at least one to-be-quoted message in the target to-be-quoted message.

In a case that the fifth input and the sixth input are present, the target information includes P to-be-quoted messages, where P is a positive integer less than or equal to K, and the P to-be-quoted messages can be the to-be-quoted messages with an adjusted positional relationship in the target to-be-quoted message.

Step 760: Display a fourth screen, where the fourth screen includes the at least one to-be-quoted message in the target to-be-quoted message.

Step 770: Receive a seventh input for a specified to-be-quoted message in the at least one to-be-quoted message, where the seventh input is used for triggering a jump to a specified application corresponding to the specified to-be-quoted message.

Step 780: Display a fifth screen according to the seventh input, where the fifth screen is a screen of the specified application including the specified to-be-quoted message and context of the specified to-be-quoted message.

After step 780, an eighth input may further be received, where the eighth input is used for viewing the context of the specified to-be-quoted message; a sixth screen is displayed according to the eighth input, where the sixth screen is a screen on which the content of the specified to-be-quoted message is replaced with an icon of the specified to-be-quoted message; a ninth input for the icon of the specified to-be-quoted message on the sixth screen is received; and the fifth screen is displayed according to the ninth input.

In this embodiment of this application, the fifth screen may further include a back icon; and a tenth input for the back icon on the fifth screen is received, and the fourth screen is displayed according to the tenth input.

The foregoing steps have been described in detail above. For specific explanation, reference may be made to the above description, and details are not repeated herein again.

In the message quoting method provided in the embodiments of this application, the first input is used on a screen of the first application to associate the target to-be-quoted message for the target session message in the second application with the target object, such that target information including at least one to-be-quoted message in the target to-be-quoted message can be sent to the target object subsequently, allowing the target to-be-quoted message in the second application to be used in the first application, thereby solving the problem that the quoting mode in the related art is not applicable to cross-application quoting scenarios. In addition, one single message can use multiple to-be-quoted messages, and positional relationship adjustment and deletion can be performed on these multiple to-be-quoted messages to better meet the flexible operation of the to-be-quoted messages. Moreover, the user can jump to the initial position of the to-be-quoted message to show the context, better helping the user understand the content of the to-be-quoted message.

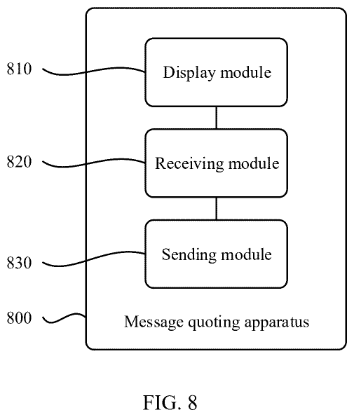

An embodiment of this application further provides a message quoting apparatus. As shown in FIG. 8, the message quoting apparatus 800 includes:
a display module 810, configured to display a first screen of a first application, where the first screen includes X first to-be-quoted messages and Y first session objects;
a receiving module 820, configured to: receive a first input from a user, where the first input is used for associating a target to-be-quoted message in the X first to-be-quoted messages with a target object in the Y first session objects, and the target to-be-quoted message includes a target session message in a second application; and receive a second input from the user, where the second input is used for instructing to send information to the target object; and a sending module 830, configured to send target information to the target object according to the second input, where the target information includes at least one to-be-quoted message in the target to-be-quoted message; where both X and Y are positive integers.

In the embodiments of this application, the display module is configured to display a first screen of a first application, where the first screen includes X first to-be-quoted messages and Y first session objects; a receiving module is configured to receive a first input from a user, where the first input is used for associating a target to-be-quoted message in the X first to-be-quoted messages with a target object in the Y first session objects, and the target to-be-quoted message includes a target session message in a second application; the receiving module is further configured to receive a second input from the user, where the second input is used for instructing to send information to the target object; and the sending module is configured to send target information to the target object according to the second input, where the target information includes at least one to-be-quoted message in the target to-be-quoted message; where both X and Y are positive integers. In this way, on a screen of the first application, the first input is used to associate the target to-be-quoted message including the target session message in the second application with the target object, such that target information including at least one to-be-quoted message in the target to-be-quoted message can be sent to the target object subsequently, allowing the target session message in the second application to be quoted in the first application, thereby solving the problem that the quoting mode in the related art is not applicable to cross-application quoting scenarios.

In an embodiment, before the displaying a first screen of a first application, the receiving module 820 is further configured to receive a third input of the user for a target session message in the second application; the display module 810 is further configured to display M application icons according to the third input, where the M application icons are used for indicating icons of applications different from the second application; the receiving module is further configured to: receive a fourth input from the user, where the fourth input is used for selecting N target application icons from the M application icons, and the N target application icons include an icon of the first application; and quote, according to the fourth input, the target session message in N target applications corresponding to the N target application icons; where N is less than or equal to M, and N and M are positive integers. In this way, the target application to which the to-be-quoted message needs to be added can be selected depending on the actual situation, where the to-be-quoted message includes the target session message in the second application, making it convenient for the target application to quote the target session message in the second application subsequently.

In an embodiment, the target to-be-quoted message includes K to-be-quoted messages, where K is a positive integer greater than or equal to 2 and K is less than or equal to X; before the receiving a second input from the user, the display module 810 is further configured to display a second screen, where the second screen includes the K to-be-quoted messages; the receiving module 820 is further configured to receive a fifth input, where the fifth input is used for adjusting a positional relationship among the K to-be-quoted messages; and the sending module is further configured to send target information to the target object according to the second input, where the target information includes the K to-be-quoted messages whose positional relationship has been adjusted. In this way, the positional relationship of the to-be-quoted messages can be adjusted, which is beneficial to better understanding of the to-be-quoted messages.

In an embodiment, the target to-be-quoted message includes K to-be-quoted messages, where K is a positive integer greater than or equal to 2 and K is less than or equal to X; before the receiving a second input from the user, the display module 810 is further configured to display a second screen, where the second screen includes the K to-be-quoted messages; the receiving module 820 is further configured to receive a sixth input, where the sixth input is used for deleting at least one of the K to-be-quoted messages; the display module 810 is further configured to display a third screen according to the second input, where the third screen includes P to-be-quoted messages, and P is a positive integer less than K; and the sending module 830 is further configured to send the target information to the target object according to the second input, where the target information includes the P to-be-quoted messages. In this way, deletion of the to-be-quoted messages can be implemented, which is conducive to the flexible use of the to-be-quoted messages to better meet user needs.

In an implementation, the target object includes L objects, where L is a positive integer greater than 1. The first input includes L sub-inputs, where one of the L sub-inputs is used for associating the target to-be-quoted message with one of the L objects. In this way, multiple objects can consume the target to-be-quoted message, implementing reuse of the target to-be-quoted message.

In an embodiment, after the sending target information to the target object according to the second input, the display module 810 is further configured to display a fourth screen, where the fourth screen includes the at least one to-be-quoted message in the target to-be-quoted message; the receiving module 820 is further configured to receive a seventh input for a specified to-be-quoted message in the at least one to-be-quoted message, where the seventh input is used for triggering a jump to a specified application corresponding to the specified to-be-quoted message; and the display module 810 is further configured to display a fifth screen according to the seventh input, where the fifth screen is a screen of the specified application including the specified to-be-quoted message and context of the specified to-be-quoted message; where the specified to-be-quoted message on the fifth screen is marked with a mark. In this way, the source and context of the specified to-be-quoted message can be easily viewed through the seventh input, which helps to understand the content of the specified to-be-quoted message more accurately.

In an embodiment, after the displaying a fifth screen, the receiving module 820 is further configured to receive an eighth input, where the eighth input is used for viewing the context of the specified to-be-quoted message; the display module 810 is further configured to display a sixth screen according to the eighth input, where the sixth screen is a screen on which the content of the specified to-be-quoted message is replaced with an icon of the specified to-be-quoted message; the receiving module 820 is further configured to receive a ninth input for the icon of the specified to-be-quoted message on the sixth screen; and the display module 810 is further configured to display the fifth screen according to the ninth input. In this way, it is convenient to return to the fifth screen containing the specified to-be-quoted message and its context through the input for the icon of the specified to-be-quoted message.

In an embodiment, the fifth screen further includes a back icon, and the receiving module 820 is further configured to: receive a tenth input for the back icon on the fifth screen; and return to the fourth screen according to the tenth input. In this way, provision of the back icon on the fifth screen makes it convenient to return to the fourth screen.

The message quoting apparatus in this embodiment of this application may be an apparatus or a component, integrated circuit, or chip in a terminal. The apparatus may be a mobile electronic device or a non-mobile electronic device. For example, the mobile electronic device may be a mobile phone, a tablet computer, a notebook computer, a palmtop computer, a vehicle-mounted electronic device, a wearable device, an Ultra-Mobile Personal Computer (UMPC), a netbook, or a Personal Digital Assistant (PDA), and the non-mobile electronic device may be a server, a Network Attached Storage (NAS), a Personal Computer (PC), a Television (TV), a teller machine, a self-service machine, or the like. This is not specifically limited in the embodiments of this application.

The message quoting apparatus in this embodiment of this application may be an apparatus having an operating system. The operating system may be an Android operating system, iOS operating system, or other possible operating system. This is not specifically limited in the embodiments of this application.

The message quoting apparatus provided in this embodiment of this application is capable of implementing various processes that are implemented by the message quoting apparatus in the method embodiments of FIG. 1 to FIG. 7. To avoid repetition, details are not described herein again.

In this embodiments of this application, a first screen of a first application is displayed, where the first screen includes X first to-be-quoted messages and Y first session objects; a first input from a user is received, where the first input is used for associating a target to-be-quoted message in the X first to-be-quoted messages with a target object in the Y first session objects, and the target to-be-quoted message includes a target session message in a second application; a second input from the user is received, where the second input is used for instructing to send information to the target object; and target information is sent to the target object according to the second input, where the target information includes at least one to-be-quoted message in the target to-be-quoted message; where both X and Y are positive integers. In this way, on a screen of the first application, the first input is used to associate the target to-be-quoted message for the target session message in the second application with the target object, such that at least one to-be-quoted message in the target to-be-quoted message can be sent to the target object subsequently, allowing the target to-be-quoted message in the second application to be quoted in the first application, thereby solving the problem that the quoting mode in the related art is not applicable to cross-application quoting scenarios.

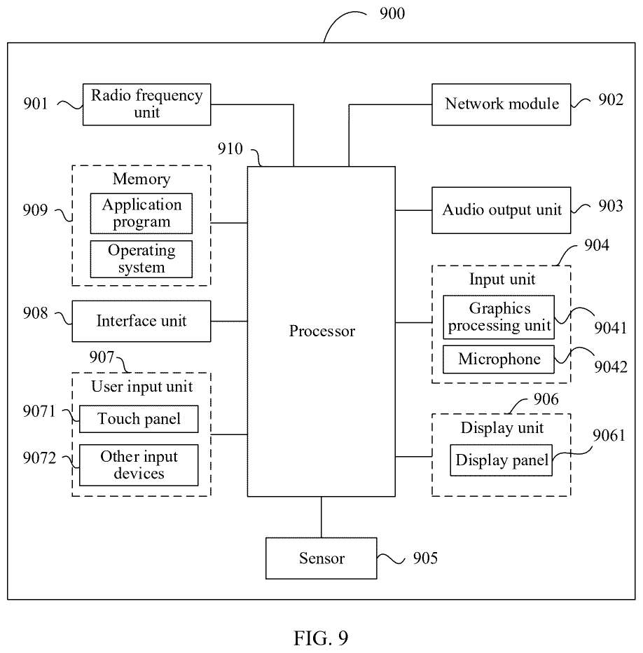

In some embodiments, as shown in FIG. 9, an embodiment of this application further provides an electronic device including a processor 910, a memory 909, and a program or instructions stored in the memory 909 and capable of running on the processor 910, where when the program or instructions are executed by the processor 910, the processes of the foregoing message quoting method embodiment are implemented, with the same technical effects achieved. To avoid repetition, details are not described herein again.

It should be noted that the electronic device in this embodiment of this application includes the aforementioned mobile electronic device and non-mobile electronic device.

FIG. 9 is a schematic diagram of a hardware structure of an electronic device according to an embodiment of this application.

The electronic device 900 includes but is not limited to components such as a radio frequency unit 901, a network module 902, an audio output unit 903, an input unit 904, a sensor 905, a display unit 906, a user input unit 907, an interface unit 908, a memory 909, and a processor 910.

Those skilled in the art can understand that the electronic device 900 may further include a power supply (for example, a battery) that supplies power to various components. The power supply may be logically connected to the processor 910 through a power management system, so that functions such as charge and discharge management and power consumption management are implemented by using the power management system. The structure of the electronic device shown in FIG. 9 does not constitute a limitation on the electronic device. The electronic device may include more or fewer components than those shown in the figure, or some components may be combined, or there may be a different component layout. Details are not described herein again. In this embodiment of this application, the electronic device includes but is not limited to a mobile phone, a tablet computer, a notebook computer, a palmtop computer, a vehicle-mounted terminal, a wearable device, a pedometer, or the like.

The display unit 906 is configured to display a first screen of a first application, where the first screen includes X first to-be-quoted messages and Y first session objects.

The user input unit 907 is configured to: receive a first input from a user, where the first input is used for associating a target to-be-quoted message in the X first to-be-quoted messages with a target object in the Y first session objects, and the target to-be-quoted message includes a target session message in a second application; and receive a second input from the user, where the second input is used for instructing to send information to the target object.

The processor 910 is configured to send target information to the target object according to the second input, where the target information includes at least one to-be-quoted message in the target to-be-quoted message; where both X and Y are positive integers.

In this embodiment of this application, a first screen of a first application is displayed, where the first screen includes X first to-be-quoted messages and Y first session objects; a first input from a user is received, where the first input is used for associating a target to-be-quoted message in the X first to-be-quoted messages with a target object in the Y first session objects, and the target to-be-quoted message includes a target session message in a second application; a second input from the user is received, where the second input is used for instructing to send information to the target object; and target information is sent to the target object according to the second input, where the target information includes at least one to-be-quoted message in the target to-be-quoted message; where both X and Y are positive integers. In this way, on a screen of the first application, the first input is used to associate the target to-be-quoted message including the target session message in the second application with the target object, such that at least one to-be-quoted message in the target to-be-quoted message can be sent to the target object subsequently, allowing the target to-be-quoted message in the second application to be quoted in the first application, thereby solving the problem that the quoting mode in the related art is not applicable to cross-application quoting scenarios.

In some embodiments, the user input unit 907 is further configured to receive a third input of the user for a target session message in the second application. The display unit 906 is further configured to display M application icons according to the third input, where the M application icons are used for indicating icons of applications different from the second application. The user input unit 907 is further configured to receive a fourth input from the user, where the fourth input is used for selecting N target application icons from the M application icons, and the N target application icons include an icon of the first application. The processor 910 is configured to quote, according to the fourth input, the target session message in N target applications corresponding to the N target application icons, where N is less than or equal to M, and both N and M are positive integers. In this way, the target application to which the to-be-quoted message needs to be added can be selected depending on the actual situation, where the to-be-quoted message includes the target session message in the second application, making it convenient for the target application to quote the target session message in the second application subsequently.

In some embodiments, the target to-be-quoted message includes K to-be-quoted messages, where K is a positive integer greater than or equal to 2 and K is less than or equal to X. The display unit 906 is further configured to, before the receiving module receives the second input from the user, display a second screen, where the second screen includes the K to-be-quoted messages. The user input unit 907 is further configured to receive a fifth input, where the fifth input is used for adjusting a positional relationship among the K to-be-quoted messages. In some embodiments, during the process of sending target information to the target object according to the second input, the processor 910 is configured to send the target information to the target object according to the second input, where the target information includes the K to-be-quoted messages whose positional relationship has been adjusted. In this way, the positional relationship of the to-be-quoted messages can be adjusted, which is beneficial to better understanding of the to-be-quoted messages.

In some embodiments, the target to-be-quoted message includes K to-be-quoted messages, where K is a positive integer greater than or equal to 2 and K is less than or equal to X. The display unit 906 is further configured to, before the receiving module receives the second input from the user, display a second screen, where the second screen includes the K to-be-quoted messages. The user input unit 907 is further configured to receive a sixth input, where the sixth input is used for deleting at least one of the K to-be-quoted messages. The display unit 906 is further configured to display a third screen according to the sixth input, where the third screen includes P to-be-quoted messages, and P is a positive integer less than K. In some embodiments, during the process of sending target information to the target object according to the second input, the processor 910 is configured to send the target information to the target object according to the second input, where the target information includes P to-be-quoted messages. In this way, deletion of the to-be-quoted messages can be implemented, which is conducive to the flexible use of the to-be-quoted messages to better meet user needs.

In some embodiments, the target object includes L objects, where L is a positive integer greater than 1. The first input includes L sub-inputs, where one of the L sub-inputs is used for associating the target to-be-quoted message with one of the L objects. In this way, multiple objects can consume the target to-be-quoted message, implementing reuse of the target to-be-quoted message.

In some embodiments, the display unit 906 is further configured to, after the sending module sends the target information to the target object, display a fourth screen, where the fourth screen includes the at least one to-be-quoted message in the target to-be-quoted message. The user input unit 907 is further configured to receive a seventh input for a specified to-be-quoted message in the at least one to-be-quoted message, where the seventh input is used for triggering a jump to a specified application corresponding to the specified to-be-quoted message. The display unit 906 is further configured to display a fifth screen according to the seventh input, where the fifth screen is a screen of the specified application including the specified to-be-quoted message and context of the specified to-be-quoted message; where the specified to-be-quoted message on the fifth screen is marked with a mark. In this way, the source and context of the specified to-be-quoted message can be easily viewed through the seventh input, which helps to understand the content of the specified to-be-quoted message more accurately.

In some embodiments, the user input unit 907 is further configured to receive an eighth input after the display unit displays the fifth screen, where the eighth input is used for instructing to view the context of the specified to-be-quoted message. The display unit 906 is further configured to display a sixth screen according to the eighth input, where the sixth screen is a screen on which content of the specified to-be-quoted message is replaced with an icon of the specified to-be-quoted message. The user input unit 907 is further configured to receive a ninth input for the icon of the specified to-be-quoted message on the sixth screen. The display unit 906 is further configured to display the fifth screen according to the ninth input.

In some embodiments, the fifth screen further includes a back icon. The user input unit 907 is further configured to receive a tenth input for the back icon on the fifth screen. The processor 910 is further configured to return to the fourth screen according to the tenth input. In this way, provision of the back icon on the fifth screen makes it convenient to return to the fourth screen.

It should be understood that in this embodiment of this application, the radio frequency unit 901 may be configured to receive and transmit information, or to receive and transmit a signal in a call process, and specially, after receiving downlink data from a base station, transmit the downlink data to the processor 910 for processing; and also transmit uplink data to the base station. Generally, the radio frequency unit 901 includes but is not limited to an antenna, at least one amplifier, a transceiver, a coupler, a low noise amplifier, a duplexer, and the like. In addition, the radio frequency unit 901 may also communicate with a network and other devices via a wireless communications system.

The electronic device provides wireless broadband Internet access for a user by using the network module 902, for example, helping the user send and receive e-mails, browse web pages, and access streaming media.

The audio output unit 903 may convert audio data received by the radio frequency unit 901 or the network module 902 or stored in the memory 909 into an audio signal and output the audio signal as a sound. In addition, the audio output unit 903 may further provide audio output (for example, a call signal received sound or a message received sound) related to a specific function performed by the electronic device 900. The audio output unit 903 includes a speaker, a buzzer, a telephone receiver, and the like.

The input unit 904 is configured to receive audio or video signals. The input unit 904 may include a Graphics Processing Unit (GPU) 9041 and a microphone 9042. The graphics processing unit 9041 processes image data of a static picture or a video obtained by an image capture apparatus (for example, a camera) in a video capture mode or an image capture mode. A processed image frame may be displayed on the display unit 906. The image frame processed by the graphics processing unit 9041 may be stored in the memory 909 (or another storage medium) or transmitted via the radio frequency unit 901 or the network module 902. The microphone 9042 is capable of receiving sounds and processing such sounds into audio data. The processed audio data can be converted, in a telephone call mode, into a format that can be transmitted via the radio frequency unit 901 to a mobile communication base station.

The electronic device 900 further includes at least one sensor 905, for example, an optical sensor, a motion sensor, and other sensors. In some embodiments, the optical sensor includes an ambient light sensor and a proximity sensor. The ambient light sensor may adjust brightness of a display panel 9061 based on intensity of ambient light, and the proximity sensor may turn off the display panel 9061 and/or backlight when the electronic device 900 moves close to an ear. As a type of motion sensor, an accelerometer sensor can detect magnitudes of accelerations in all directions (usually three axes), can detect a magnitude and a direction of gravity when in a static state, and can be applied to posture recognition (such as screen switching between portrait and landscape, related games, and magnetometer posture calibration) of the electronic device, functions related to vibration recognition (such as a pedometer and tapping), and the like. The sensor 905 may also include a fingerprint sensor, a pressure sensor, an iris sensor, a molecular sensor, a gyroscope, a barometer, a hygrometer, a thermometer, an infrared sensor, and the like. Details are not described herein.

The display unit 906 is configured to display information input by the user or information provided to the user. The display unit 906 may include the display panel 9061. The display panel 9061 may be configured in a form of a Liquid Crystal Display (LCD), an Organic Light-Emitting Diode (OLED), or the like.

The user input unit 907 may be configured to: receive input digit or character information and generate key signal input related to user settings and function control of the electronic device. In some embodiments, the user input unit 907 includes a touch panel 9071 and other input devices 9072. The touch panel 9071 is also referred to as a touchscreen, and may collect a touch operation of the user on or near the touch panel (for example, an operation performed on or near the touch panel 9071 by the user by using any appropriate object or accessory such as a finger or a stylus). The touch panel 9071 may include two parts: a touch detection apparatus and a touch controller. The touch detection apparatus detects a touch azimuth of a user, detects a signal brought by a touch operation, and transmits the signal to the touch controller. The touch controller receives touch information from the touch detection apparatus, converts the touch information into touchpoint coordinates, transmits the touchpoint coordinates to the processor 910, and can receive a command transmitted by the processor 910 and execute the command. In addition, the touch panel 9071 may be implemented in a plurality of forms, for example, as a resistive, a capacitive, an infrared, or a surface acoustic wave touch panel. The user input unit 907 may further include other input devices 9072 in addition to the touch panel 9071. In some embodiments, the other input devices 9072 may include but are not limited to a physical keyboard, a function button (for example, a volume button or a power on/off button), a trackball, a mouse, and a joystick. Details are not described herein. Further, the touch panel 9071 may cover the display panel 9061. When detecting a touch operation on or near the touch panel 9071, the touch panel 9071 transmits the touch operation to the processor 910 to determine a type of a touch event. Then, the processor 910 provides a corresponding visual output on the display panel 9061 based on the type of the touch event. In FIG. 9, the touch panel 9071 and the display panel 9061 serve as two separate components to implement input and output functions of the electronic device. However, in some embodiments, the touch panel 9071 and the display panel 9061 may be integrated to implement the input and output functions of the electronic device. This is not specifically limited herein.

The interface unit 908 is an interface for connecting an external apparatus to the electronic device 900. For example, the external apparatus may include a wired or wireless headphone port, an external power supply (or battery charger) port, a wired or wireless data port, a memory card port, a port for connecting an apparatus with an identification module, an audio Input/Output (I/O) port, a video I/O port, a headset port, or the like. The interface unit 908 may be configured to receive an input (for example, data information or power) from an external apparatus and transmit the received input to one or more elements in the electronic device 900, or may be configured to transmit data between the electronic device 900 and the external apparatus.

The memory 909 may be configured to store software programs and various data. The memory 909 may mainly include a program storage area and a data storage area. The program storage area may store an operating system, an application program required for at least one function (for example, a sound play function and an image play function), and the like. The data storage area may store data created based on use of the mobile phone (for example, audio data and a phone book), and the like. In addition, the memory 909 may include a high-speed random access memory, or may further include a non-volatile memory, for example, at least one magnetic disk storage device, flash memory, or other volatile solid-state storage devices.

The processor 910 is a control center of the electronic device, uses various interfaces and lines to connect all parts of the entire electronic device, and performs various functions and data processing of the electronic device by running or executing the software program and/or module stored in the memory 909 and invoking data stored in the memory 909, thereby performing overall monitoring on the electronic device. The processor 910 may include one or more processing units. For example, the processor 910 may integrate an application processor and a modem processor. The application processor mainly processes the operating system, a user interface, an application program, and the like. The modem processor mainly processes wireless communication. In some embodiments, it can be understood that the modem processor may be not integrated in the processor 910.

In addition, the electronic device 900 includes some functional modules that are not shown. Details are not described herein.

An embodiment of this application further provides a readable storage medium, where the readable storage medium stores a program or instructions, and when the program or instructions are executed by a processor, the processes of the foregoing message quoting method embodiment are implemented, with the same technical effects achieved. To avoid repetition, details are not described herein again.

The processor is the processor in the electronic device in the foregoing embodiments. The readable storage medium includes a computer-readable storage medium such as a computer Read-Only Memory (ROM), a Random Access Memory (RAM), a magnetic disk, or an optical disc.

An embodiment of this application further provides a chip, where the chip includes a processor and a communication interface. The communication interface is coupled to the processor, and the processor is configured to run a program or instructions to implement the processes of the foregoing message quoting method embodiment, with the same technical effects achieved. To avoid repetition, details are not described herein again.

It should be understood that the chip mentioned in the embodiments of this application may also be referred to as a system-level chip, a system chip, a chip system, a system-on-chip, or the like.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

According to the descriptions of the foregoing embodiments, persons skilled in the art can clearly understand that the method in the foregoing embodiments may be implemented by software in combination with a necessary general hardware platform. In some embodiments, the method in the foregoing embodiments may be implemented by hardware. However, in many cases, the former is an example implementation. Based on such an understanding, the technical solutions of this application essentially, or the part contributing to the prior art may be implemented in a form of a software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A message quoting method, comprising:
displaying a first screen of a first application, wherein the first screen comprises X first to-be-quoted messages and Y first session objects;
receiving a first input from a user, wherein the first input is used to associate a target to-be-quoted message in the X first to-be-quoted messages with a target object in the Y first session objects, and the target to-be-quoted message comprises a target session message in a second application;
receiving a second input from the user, wherein the second input is used to instruct sending information to the target object; and
sending target information to the target object according to the second input, wherein the target information comprises at least one to-be-quoted message in the target to-be-quoted message;
wherein both X and Y are positive integers.

2. The message quoting method according to claim 1, wherein before the displaying a first screen of a first application, the method further comprises:
receiving a third input from the user in response to the target session message in the second application;
displaying M application icons according to the third input, wherein the M application icons are used to indicate icons of applications different from the second application;
receiving a fourth input from the user, wherein the fourth input is used to select N target application icons from the M application icons, and the N target application icons comprise an icon of the first application; and
quoting, according to the fourth input, the target session message in N target applications corresponding to the N target application icons;
wherein N is less than or equal to M, and N and M are positive integers.

3. The message quoting method according to claim 1, wherein the target to-be-quoted message comprises K to-be-quoted messages, wherein K is a positive integer greater than or equal to 2 and K is less than or equal to X;
before the receiving a second input from the user, the method further comprises:
displaying a second screen, wherein the second screen comprises the K to-be-quoted messages; or
receiving a fifth input, wherein the fifth input is used to adjust a positional relationship among the K to-be-quoted messages;
the sending target information to the target object according to the second input comprises:
sending the target information to the target object according to the second input, wherein the target information comprises K to-be-quoted messages whose positional relationship has been adjusted.

4. The message quoting method according to claim 1, wherein the target to-be-quoted message comprises K to-be-quoted messages, wherein K is a positive integer greater than or equal to 2 and K is less than or equal to X;
before the receiving a second input from the user, the method further comprises:
displaying a second screen, wherein the second screen comprises the K to-be-quoted messages;
receiving a sixth input, wherein the sixth input is used to delete at least one of the K to-be-quoted messages; and
displaying a third screen according to the sixth input, wherein the third screen comprises P to-be-quoted messages, and P is a positive integer less than K; and
the sending target information to the target object according to the second input comprises:
sending the target information to the target object according to the second input, wherein the target information comprises the P to-be-quoted messages.

5. The message quoting method according to claim 1, wherein after the sending target information to the target object according to the second input, the method further comprises:
displaying a fourth screen, wherein the fourth screen comprises the at least one to-be-quoted message in the target to-be-quoted message;
receiving a seventh input for a specified to-be-quoted message in the at least one to-be-quoted message, wherein the seventh input is used to trigger a jump to a specified application corresponding to the specified to-be-quoted message; and
displaying a fifth screen according to the seventh input, wherein the fifth screen is a screen of the specified application comprising the specified to-be-quoted message and a context of the specified to-be-quoted message;
wherein the specified to-be-quoted message on the fifth screen is marked with a mark.

6. The message quoting method according to claim 5, wherein after the displaying a fifth screen, the method further comprises:
receiving an eighth input, wherein the eighth input is used to view the context of the specified to-be-quoted message;
displaying a sixth screen according to the eighth input, wherein the sixth screen is a screen on which the content of the specified to-be-quoted message is replaced with an icon of the specified to-be-quoted message;
receiving a ninth input for the icon of the specified to-be-quoted message on the sixth screen; and
displaying the fifth screen according to the ninth input.

7. An electronic device, wherein the electronic device comprises a processor, a memory, and a program or instructions stored in the memory and capable of running on the processor, wherein the program or instructions, when executed by the processor, cause the processor to perform operations comprising:
displaying a first screen of a first application, wherein the first screen comprises X first to-be-quoted messages and Y first session objects;
receiving a first input from a user, wherein the first input is used to associate a target to-be-quoted message in the X first to-be-quoted messages with a target object in the Y first session objects, and the target to-be-quoted message comprises a target session message in a second application;
receiving a second input from the user, wherein the second input is used to instruct sending information to the target object; and
sending target information to the target object according to the second input, wherein the target information comprises at least one to-be-quoted message in the target to-be-quoted message;
wherein both X and Y are positive integers.

8. The electronic device according to claim 7, wherein before the displaying a first screen of a first application, the program or instructions, when executed by the processor, cause the processor to further perform:
receiving a third input from the user in response to the target session message in the second application;
displaying M application icons according to the third input, wherein the M application icons are used to indicate icons of applications different from the second application;
receiving a fourth input from the user, wherein the fourth input is used to select N target application icons from the M application icons, and the N target application icons comprise an icon of the first application; and
quoting, according to the fourth input, the target session message in N target applications corresponding to the N target application icons;
wherein N is less than or equal to M, and N and M are positive integers.

9. The electronic device according to claim 7, wherein the target to-be-quoted message comprises K to-be-quoted messages, wherein K is a positive integer greater than or equal to 2 and K is less than or equal to X;
before the receiving a second input from the user, the program or instructions, when executed by the processor, cause the processor to further perform:
displaying a second screen, wherein the second screen comprises the K to-be-quoted messages; or
receiving a fifth input, wherein the fifth input is used to adjust a positional relationship among the K to-be-quoted messages;
the sending target information to the target object according to the second input comprises:
sending the target information to the target object according to the second input, wherein the target information comprises K to-be-quoted messages whose positional relationship has been adjusted.

10. The electronic device according to claim 7, wherein the target to-be-quoted message comprises K to-be-quoted messages, wherein K is a positive integer greater than or equal to 2 and K is less than or equal to X;
before the receiving a second input from the user, the program or instructions, when executed by the processor, cause the processor to further perform:
displaying a second screen, wherein the second screen comprises the K to-be-quoted messages;
receiving a sixth input, wherein the sixth input is used to delete at least one of the K to-be-quoted messages; and
displaying a third screen according to the sixth input, wherein the third screen comprises P to-be-quoted messages, and P is a positive integer less than K; and
the sending target information to the target object according to the second input comprises:
sending the target information to the target object according to the second input, wherein the target information comprises the P to-be-quoted messages.

11. The electronic device according to claim 7, wherein after the sending target information to the target object according to the second input, the program or instructions, when executed by the processor, cause the processor to further perform:
displaying a fourth screen, wherein the fourth screen comprises the at least one to-be-quoted message in the target to-be-quoted message;
receiving a seventh input for a specified to-be-quoted message in the at least one to-be-quoted message, wherein the seventh input is used to trigger a jump to a specified application corresponding to the specified to-be-quoted message; and
displaying a fifth screen according to the seventh input, wherein the fifth screen is a screen of the specified application comprising the specified to-be-quoted message and a context of the specified to-be-quoted message;
wherein the specified to-be-quoted message on the fifth screen is marked with a mark.

12. The electronic device according to claim 11, wherein after the displaying a fifth screen, the program or instructions, when executed by the processor, cause the processor to further perform:
receiving an eighth input, wherein the eighth input is used to view the context of the specified to-be-quoted message;
displaying a sixth screen according to the eighth input, wherein the sixth screen is a screen on which the content of the specified to-be-quoted message is replaced with an icon of the specified to-be-quoted message;
receiving a ninth input for the icon of the specified to-be-quoted message on the sixth screen; and
displaying the fifth screen according to the ninth input.

13. A computer-readable medium storing a program or instructions that, when executed by a processor, cause the processor to perform operations comprising:
displaying a first screen of a first application, wherein the first screen comprises X first to-be-quoted messages and Y first session objects;
receiving a first input from a user, wherein the first input is used to associate a target to-be-quoted message in the X first to-be-quoted messages with a target object in the Y first session objects, and the target to-be-quoted message comprises a target session message in a second application;
receiving a second input from the user, wherein the second input is used to instruct sending information to the target object; and
sending target information to the target object according to the second input, wherein the target information comprises at least one to-be-quoted message in the target to-be-quoted message;
wherein both X and Y are positive integers.

14. The computer-readable medium according to claim 13, wherein before the displaying a first screen of a first application, the program or instructions, when executed by the processor, cause the processor to further perform:
receiving a third input from the user in response to the target session message in the second application;
displaying M application icons according to the third input, wherein the M application icons are used to indicate icons of applications different from the second application;
receiving a fourth input from the user, wherein the fourth input is used to select N target application icons from the M application icons, and the N target application icons comprise an icon of the first application; and
quoting, according to the fourth input, the target session message in N target applications corresponding to the N target application icons;
wherein N is less than or equal to M, and N and M are positive integers.

15. The computer-readable medium according to claim 13, wherein the target to-be-quoted message comprises K to-be-quoted messages, wherein K is a positive integer greater than or equal to 2 and K is less than or equal to X;
before the receiving a second input from the user, the program or instructions, when executed by the processor, cause the processor to further perform:
displaying a second screen, wherein the second screen comprises the K to-be-quoted messages; or
receiving a fifth input, wherein the fifth input is used to adjust a positional relationship among the K to-be-quoted messages;
the sending target information to the target object according to the second input comprises:
sending the target information to the target object according to the second input, wherein the target information comprises K to-be-quoted messages whose positional relationship has been adjusted.

16. The computer-readable medium according to claim 13, wherein the target to-be-quoted message comprises K to-be-quoted messages, wherein K is a positive integer greater than or equal to 2 and K is less than or equal to X;
before the receiving a second input from the user, the program or instructions, when executed by the processor, cause the processor to further perform:
displaying a second screen, wherein the second screen comprises the K to-be-quoted messages;
receiving a sixth input, wherein the sixth input is used to delete at least one of the K to-be-quoted messages; and
displaying a third screen according to the sixth input, wherein the third screen comprises P to-be-quoted messages, and P is a positive integer less than K; and
the sending target information to the target object according to the second input comprises:
sending the target information to the target object according to the second input, wherein the target information comprises the P to-be-quoted messages.

17. The computer-readable medium according to claim 13, wherein after the sending target information to the target object according to the second input, the program or instructions, when executed by the processor, cause the processor to further perform:
displaying a fourth screen, wherein the fourth screen comprises the at least one to-be-quoted message in the target to-be-quoted message;
receiving a seventh input for a specified to-be-quoted message in the at least one to-be-quoted message, wherein the seventh input is used to trigger a jump to a specified application corresponding to the specified to-be-quoted message; and
displaying a fifth screen according to the seventh input, wherein the fifth screen is a screen of the specified application comprising the specified to-be-quoted message and a context of the specified to-be-quoted message;
wherein the specified to-be-quoted message on the fifth screen is marked with a mark.

18. The computer-readable medium according to claim 17, wherein after the displaying a fifth screen, the program or instructions, when executed by the processor, cause the processor to further perform:
receiving an eighth input, wherein the eighth input is used to view the context of the specified to-be-quoted message;
displaying a sixth screen according to the eighth input, wherein the sixth screen is a screen on which the content of the specified to-be-quoted message is replaced with an icon of the specified to-be-quoted message;
receiving a ninth input for the icon of the specified to-be-quoted message on the sixth screen; and
displaying the fifth screen according to the ninth input.
